(19) United States
(12) Patent Application Publication
(10) Pub. No.: US 2026/0361386 A1
(43) Pub. Date: Nov. 12, 2026

(54) WIRELESS TRANSMIT/RECEIVE UNIT AND METHOD FOR DETERMINING AND REPORTING TRANSMIT/RECEIVE BEAM PAIRS ASSOCIATED WITH A UNICAST SIDELINK

(71) Applicant: InterDigital Patent Holdings, Inc., Wilmington, DE (US)

(72) Inventors: Tao DENG, New York, NY (US); Moon-il LEE, Melville, NY (US); Tuong HOANG, Montreal (CA); Aata EL HAMSS, Laval (CA)

(21) Appl. No.: 19/156,059

(22) PCT Filed: Feb. 14, 2024
(86) PCT No.: PCT/US2024/015784

§ 371 Date: Aug. 13, 2025

Related U.S. Application Data
(60) Provisional application No. 63/445,522, filed on Feb. 14, 2023.

(51) Int. Cl. H04B 7/06; H04B 17/318; H04L 5/00; H04W 24/10; H04W 92/18

(52) U.S. Cl. CPC H04B 7/0696; H04B 17/328; H04L 5/005; H04W 24/10; H04W 92/18

(57) ABSTRACT

The disclosure pertains to procedures, methods, architectures, apparatus, systems, devices, and computer program products for, and/or directed to sidelink beamformed operation. A method implemented in a first wireless transmit/receive unit (WTRU) may include receiving beam configuration information from a second WTRU; receiving a set of sidelink channel state information reference signal (CSI-RS) transmissions from the second WTRU; performing measurement based on the set of sidelink CSI-RS transmissions; determining an active beam pair based on the measurement; and determining a sidelink occasion based on the beam configuration information. In various embodiments, the sidelink occasion may be associated with a first RX beam of the second WTRU corresponding to the first TX beam of the second WTRU in the active beam pair. The method may include transmitting a beam pair report in the sidelink occasion using the first TX beam of the first WTRU.

### CROSS-REFERENCE TO RELATED APPLICATIONS

This application claims the benefit of U.S. Patent Application No. 63/445,522 filed Feb. 14, 2023, which is incorporated herein by reference in its entirety.

### TECHNICAL FIELD

This disclosure pertains to procedures, methods, architectures, apparatus, systems, devices, and computer program products for, and/or directed to determining beamforming parameters for sidelink operation by determining and reporting transmit/receive beam pairs associated with a unicast sidelink.

### BACKGROUND

Sidelink beamforming operation may allow to improve performances of sidelink transmissions. Embodiments described herein have been designed with the foregoing in mind.

### BRIEF SUMMARY

Methods, architectures, apparatuses, and systems directed to sidelink beamforming operation are described herein. In an embodiment, a first wireless transmit/receive unit (WTRU) is described. The first WTRU may include circuitry including any of transmitter, a receiver, a processor, and a memory. The circuitry may be configured to receive beam configuration information from a second WTRU. The circuitry may be configured to receive a set of sidelink channel state information reference signal (CSI-RS) transmissions from the second WTRU and to perform measurement based on the set of sidelink CSI-RS transmissions. The circuitry may be configured to determine an active beam pair based on the measurement. In various embodiments, the active beam pair may include a first receive (RX) beam of the first WTRU and a first transmit (TX) beam of the second WTRU. The circuitry may be configured to determine a first TX beam of the first WTRU corresponding to the first RX beam of the first WTRU in the active beam pair. The circuitry may be configured to determine a sidelink occasion based on the beam configuration information. In various embodiments, the sidelink occasion may be associated with a first RX beam of the second WTRU corresponding to the first TX beam of the second WTRU in the active beam pair. The circuitry may be configured to transmit a beam pair report in the sidelink occasion using the first TX beam of the first WTRU.

In an embodiment, a first method implemented in a first WTRU is described. The first method may include receiving beam configuration information from a second WTRU. The first method may include receiving a set of sidelink channel state information reference signal (CSI-RS) transmissions from the second WTRU and performing measurement based on the set of sidelink CSI-RS transmissions. The first method may include determining an active beam pair based on the measurement. In various embodiments, the active beam pair may include a first receive (RX) beam of the first WTRU and a first transmit (TX) beam of the second WTRU. The first method may include determining a first TX beam of the first WTRU corresponding to the first RX beam of the first WTRU in the active beam pair. The first method may include determining a sidelink occasion based on the beam configuration information. In various embodiments, the sidelink occasion may be associated with a first RX beam of the second WTRU corresponding to the first TX beam of the second WTRU in the active beam pair. The first method may include transmitting a beam pair report in the sidelink occasion using the first TX beam of the first WTRU.

In an embodiment, a first WTRU is described. The first WTRU may include circuitry including any of transmitter, a receiver, a processor, and a memory. The circuitry may be configured to receive beam configuration information from a second WTRU and to transmit a set of sidelink channel state information reference signal (CSI-RS) transmissions to the second WTRU using multiple transmit (TX) beams. The circuitry may be configured to receive a beam pair report from the second WTRU indicating an active beam pair. The circuitry may be configured to determine a set of candidate slots based on the beam configuration information. In various embodiments, the set of candidate slots may be associated with a receive (RX) beam of the second WTRU in the active beam pair. The circuitry may be configured to transmit a unicast sidelink transmission in a slot of the set of candidate slots using a TX beam of the active beam pair.

In an embodiment, a second method implemented in a first WTRU is described. The second method may include receiving beam configuration information from a second WTRU and transmitting a set of sidelink channel state information reference signal (CSI-RS) transmissions to the second WTRU using multiple transmit (TX) beams. The second method may include receiving a beam pair report from the second WTRU indicating an active beam pair. The second method may include determining a set of candidate slots based on the beam configuration information. In various embodiments, the set of candidate slots may be associated with a receive (RX) beam of the second WTRU in the active beam pair. The second method may include transmitting a unicast sidelink transmission in a slot of the set of candidate slots using a TX beam of the active beam pair.

In an embodiment, a first WTRU is described. The first WTRU may include circuitry including any of transmitter, a receiver, a processor, and a memory. The circuitry may be configured to transmit a first set of sidelink channel state information reference signal (CSI-RS) transmissions using a transmit (TX) beam of an active beam pair of a sidelink with a second WTRU. The circuitry may be configured to transmit a second set of sidelink CSI-RS transmissions using a TX beam of an alternative beam pair of the sidelink. The circuitry may be configured to determine a beam failure to have occurred based on detection of a first sidelink transmission from the second WTRU corresponding to the first set of side link CSI-RS transmissions and detection of a second sidelink transmission corresponding to the second set of sidelink CSI-RS transmissions. Responsive to a determination that a beam failure has occurred, the circuitry may be configured to transmit a third set of sidelink CSI-RS transmissions using multiple TX beams to request beam pair reporting.

In an embodiment, a third method implemented in a first WTRU is described. The third method may include transmitting a first set of sidelink channel state information reference signal (CSI-RS) transmissions using a transmit (TX) beam of an active beam pair of a sidelink with a second WTRU. The third method may include transmitting a second set of sidelink CSI-RS transmissions using a TX beam of an alternative beam pair of the sidelink. The third method may include determining a beam failure to have occurred based on detection of a first sidelink transmission from the second WTRU corresponding to the first set of side link CSI-RS transmissions and detection of a second sidelink transmission corresponding to the second set of sidelink CSI-RS transmissions. Responsive to a determination that a beam failure has occurred, the third method may include transmitting a third set of sidelink CSI-RS transmissions using multiple TX beams to request beam pair reporting.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 depicts a receive beam periodic sweeping pattern;

FIG. 3 depicts an example method for determining and reporting of transmit/receive (TX/RX) beam pairs associated with a unicast sidelink (SL);

FIG. 4 depicts an example method for resource selection for a unicast SL transmission based on associated TX/RX beam pair;

FIG. 5 depicts an example method for CSI-RS transmissions for beam failure detection;

FIG. 6 is a flow chart illustrating an example process for determining beamforming parameters for sidelink operation by determining and reporting transmit/receive beam pairs associated with a unicast sidelink;

FIG. 7 is a flow chart illustrating an example process for determining beamforming parameters for sidelink operation via resource selection based on transmit/receive beam pair reporting from another wireless transmit/receive unit associated with a unicast sidelink;

FIG. 8 is a flow chart illustrating an example process for determining beamforming parameters for sidelink operation using sidelink beam failure detection and recovery techniques; and

FIG. 9 is a flow chart illustrating an example process for determining and reporting beam pairs associated with a unicast sidelink.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

### Example Communications System

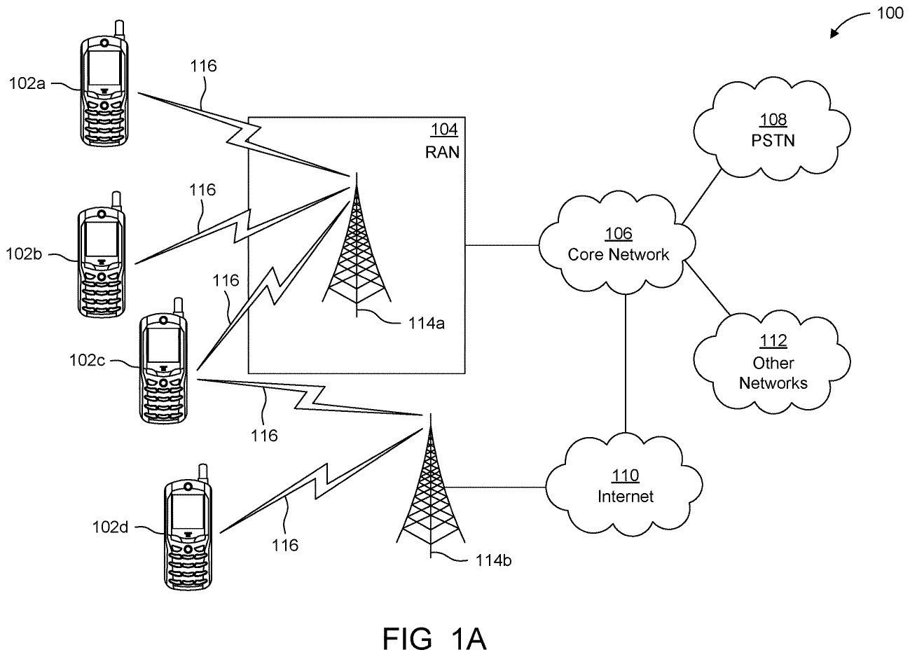

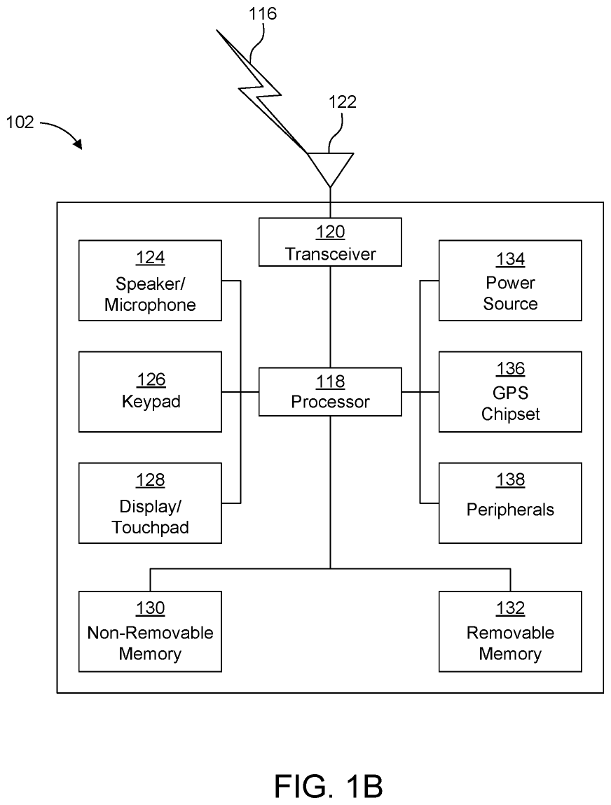

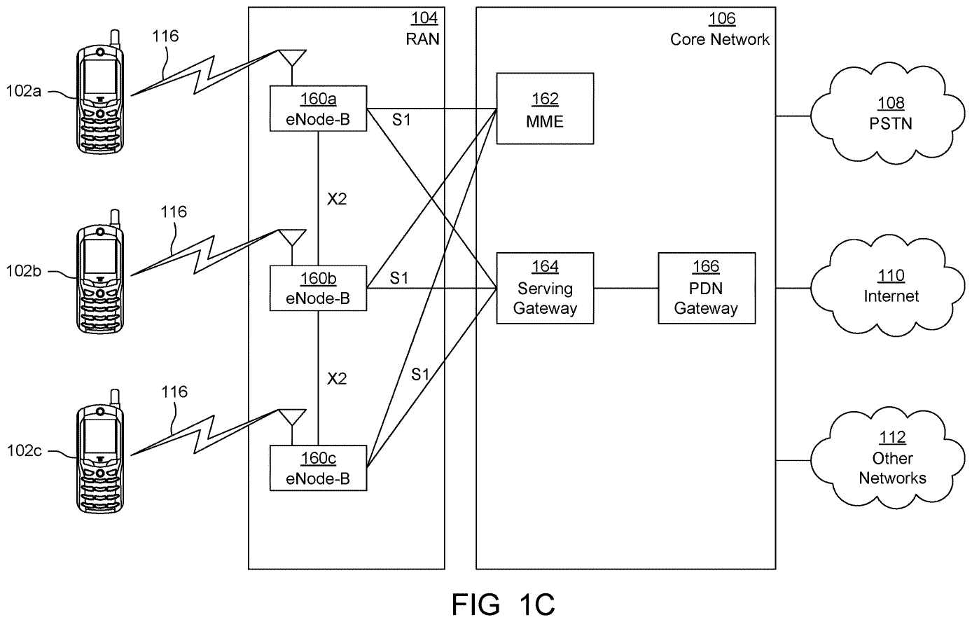

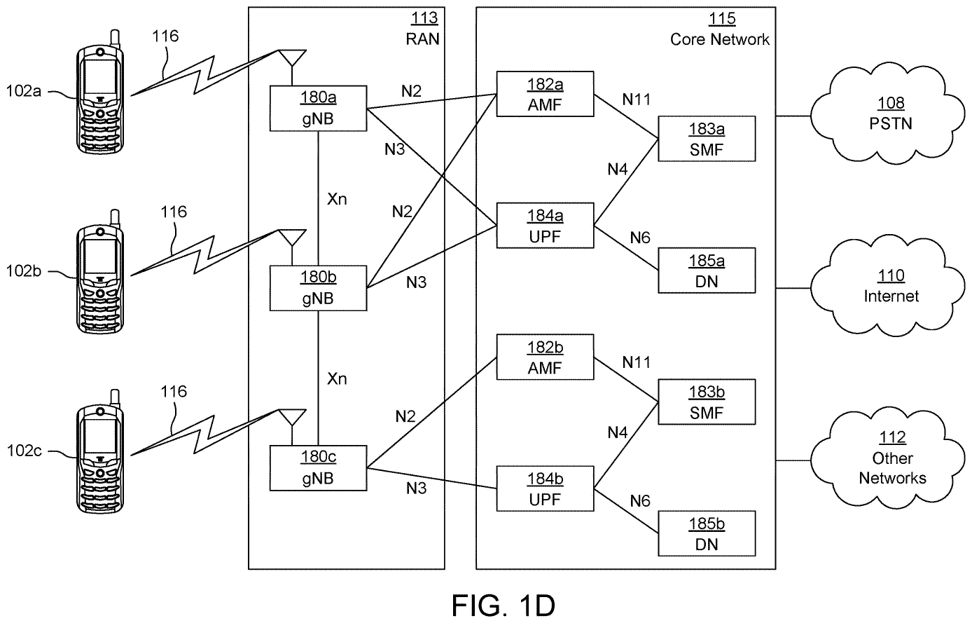

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein the terms “base station”, “network”, and “gNB”, collectively “the network” may be used interchangeably to designate any network element such as e.g., a network element acting as a serving base station. Embodiments described herein are not limited to gNBs and are applicable to any other type of base stations.

For the sake of clarity, satisfying, failing to satisfy a condition, and configuring condition parameter(s) are described throughout embodiments described herein as relative to a threshold (e.g., greater, or lower than) a (e.g., threshold) value, configuring the (e.g., threshold) value, etc. For example, satisfying a condition may be described as being above a (e.g., threshold) value, and failing to satisfy a condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report something”, and “the WTRU may be configured to report something”, is equivalent or may be used interchangeably with “the WTRU may transmit (e.g., reporting) information indicating something”.

In embodiments described herein, “a” and “an” and similar phrases are to be interpreted as “one or more” and “at least one”. Similarly, any term which ends with the suffix‘(s)’ is to be interpreted as “one or more” and “at least one”. The term “may” is to be interpreted as “may, for example”.

A symbol “/” (e.g., forward slash) may be used herein to represent “and/or”, where for example, “A/B” may imply “A and/or B”.

Beamformed Sidelink Operation in Frequency Range 2 (FR2) Licensed Spectrum The third generation partnership project (3GPP) R18 Working Item (WI) of sidelink (SL) evolution specifies the study of enhanced beamformed sidelink operation in the Frequency Range 2 (FR2) licensed spectrum. The study is expected to include a set of functions of beam management, e.g., beam pairing, beam update, and beam failure recovery.

Uu beam management is performed in a centralized manner by the gNB. Downlink (DL) beam determination relies on a periodic DL reference signal transmission, e.g., synchronization signal block (SSB) or channel state information reference signal (CSI-RS). The index of the SSB or CSI-RS may be used as a transmission configuration indication (TCI) state indication to establish a quasi co location (QCL) relationship between a reference signal and a physical downlink control channel (PDCCH) or physical downlink shared channel (PDSCH) transmission.

A WTRU may receive a TCI state indication in a media access control control element (MAC CE) for physical downlink control channel (PDCCH) monitoring. The index of a reference signal indicated in the TCI state may allow the WTRU to identify the spatial QCL with the reference signal and apply an identical DL reception spatial filter configuration to receive the physical sidelink control channel (PSCCH). A similar TCI state indication for a physical sidelink control channel (PSSCH) may be included in PDCCH scheduling the PSSCH. Based on a WTRU's measurement on the periodical DL reference signal transmissions, a gNB can update the TCI state for a WTRU (e.g., each WTRU).

UL beam determination for physical uplink control channel (PUCCH) and physical uplink shared channel (PUSCH) may be based on beam correspondence, e.g., a DL reception spatial filter configuration may be applied for an uplink transmission. When the beam correspondence is not assumed (e.g., applicable) for a WTRU, the gNB may perform UL reference signal measurement and may indicate a sounding reference signal (SRS) resource indication (SRI) for an uplink (UL) transmission. A WTRU may transmit using an uplink beam corresponding to the one used in a previous SRS transmission.

(E.g., current) Uu beam management is based on TCI state to establish a QCL relationship between a reference signal, e.g., SSB or CSI-RS, and a PDCCH or PDSCH transmission. The DL reference signal transmission may establish a reference after (e.g., once) a WTRU may have completed an initial access to a gNB. A WTRU may monitor one DL from a gNB and may align the reception beam in a (e.g., each) configured PDCCH monitoring occasion. Considering PDCCH and PDSCH may be time division multiplexed (TDMed) for a (e.g., given) WTRU, a WTRU may be able to receive PDCCH in one DL TX beam and (e.g., then) PDSCH in a different DL TX beam according to the TCI state indicated in PDCCH.

In sidelink (SL), the PSCCH and PSSCH may be time and frequency multiplexed and may apply the same beamforming configuration, e.g., may use the same TX beam. For example, a WTRU may not adjust the RX beam to receive PSSCH in a different beam based on PSCCH information. In an example, a WTRU may operate multiple SLs from different WTRUs, and in a TTI (e.g., in each TTI), the WTRU may not know when and from which direction it may receive a transmission in a (e.g., given) SL slot. For example, the WTRU may not be able to align the RX beam to receive a unicast SL. In an example, there may be no periodic SL reference signal transmission to establish a TCI state reference. A new beam management framework, as described herein may allow to enable SL beamformed operation.

### Terminology

### TX Beam

A SL transmit beam, referred to herein as a TX beam may be defined as and/or may denote one or more of (1) a WTRU SL transmit (TX) configuration, (2) A WTRU SL transmit (TX) spatial configuration, (3) A WTRU SL transmit (TX) spatial filter, (4) a set of antenna element weights applied to one or more antenna panels used for a WTRU SL transmission, (5) a WTRU transmission in a (e.g., unique) steering direction characterized by any of (i) beam width, (ii) beam gain, (iii) beam center, and (iv) beam peak lobe, which parameters may be determined by any of (i) a WTRU SL TX configuration, (ii) a WTRU SL TX spatial configuration, (iii) a WTRU SL TX spatial filter, and (iv) a set of antenna element weights applied for one or more antenna panels used for a WTRU SL transmission, and (6) a radiation pattern emitted from an antenna port using any of (i) a WTRU SL TX configuration, (ii) a WTRU SL TX spatial configuration, (iii) a WTRU SL TX spatial filter, and (iv) a set of antenna element weights applied for one or more antenna panels used for a WTRU SL transmission.

A WTRU may apply one TX beam for a SL transmission in a (e.g., given) SL slot.

### TX Beam Indication

A TX beam may be indicated by one or more of (1) a (pre)configured numeric index and (2) a numeric index of a SL reference signal transmission, e.g., any of a SL SSB, SL CSI-RS, PSCCH demodulation reference signal (DMRS), PSSCH DMRS, or a SL total radiated sensitivity (TRS) transmitted using the TX beam.

### RX Beam

A SL receive beam, referred to herein as a RX beam may be defined as and/or may denote one or more of (1) a WTRU SL receive (RX) configuration, (2) a WTRU SL receive (RX) spatial configuration, (3) a WTRU SL receive (RX) spatial filter, (4) a set of antenna element weights applied to one or more antenna panels used for a WTRU SL reception, and (5) a WTRU reception in a (e.g., unique) steering direction characterized by any of (i) beam width, (ii) beam gain, (iii) beam center, and (iv) beam peak lobe, which parameters may be determined by any of (i) a WTRU SL RX configuration, (ii) a WTRU SL RX spatial configuration, (iii) a WTRU SL RX spatial filter, and (iv) a set of antenna element weights applied for one or more antenna panels used for a WTRU SL reception.

A WTRU may apply one RX beam for a SL transmission in a (e.g., given) SL slot.

### RX Beam Indication

A RX beam may be indicated by one or more of (1) a (pre)configured numeric index, (2) a numeric index of a SL reference signal reception, e.g., any of a SL SSB, SL CSI-RS, PSCCH DMRS, PSSCH DMRS, or a SL TRS transmitted using the RX beam, and (3) a corresponding TX beam indication.

A corresponding TX beam indication may be used for RX beam indication if a WTRU supports beam correspondence.

### LOS/NLOS Measurement

A WTRU may perform an estimate of likelihood of line-of-sight (LOS) propagation condition over a SL from a peer WTRU. The estimate may be based on a set of measurements on a SL transmission from the peer WTRU, e.g., a CSI-RS transmission. The measurements may include any of Doppler shift, Doppler spread, average delay, and delay spread of multi-paths detected on the CSI-RS transmission. A WTRU may determine a LOS condition likelihood value based on of a (pre)configured scale.

In one example, a binary scale may be (pre)configured and a WTRU may determine a zero for non-line of sight (NLOS) condition and one for LOS condition. In another example, a scale between 0 to 1 with a step size of 0.1 may be (pre)configured and a WTRU may determine a zero for NLOS condition and one for LOS condition and interim values to indicate a probability of LOS condition.

In embodiments described herein the terms reference signal received power (RSRP) and L1-RSRP may be used interchangeably to refer to a reference signal received power measurement.

Physical sidelink feedback channel (PSFCH), physical sidelink control channel (PSCCH), and physical sidelink shared channel (PSSCH) are used as examples of sidelink transmissions for describing sidelink beamforming operation. Embodiments described herein are not limited to PSFCH/PSCCH/PSSCH transmissions and sidelink beamforming operation described herein may be applicable to any kind of SL transmission.

In embodiment described herein, the terms “RX/TX beam pair”, “TX/RX beam pair” and “beam pair” may be used interchangeably to refer to a (e.g., first) RX beam of a (e.g., first) WTRU and a (e.g., first) TX beam of a second/peer WTRU.

In embodiment described herein, the terms “RX beam pattern configuration”, “RX beam configuration information” and “beam configuration information” may be used interchangeably.

### RX Beam Pattern Configuration

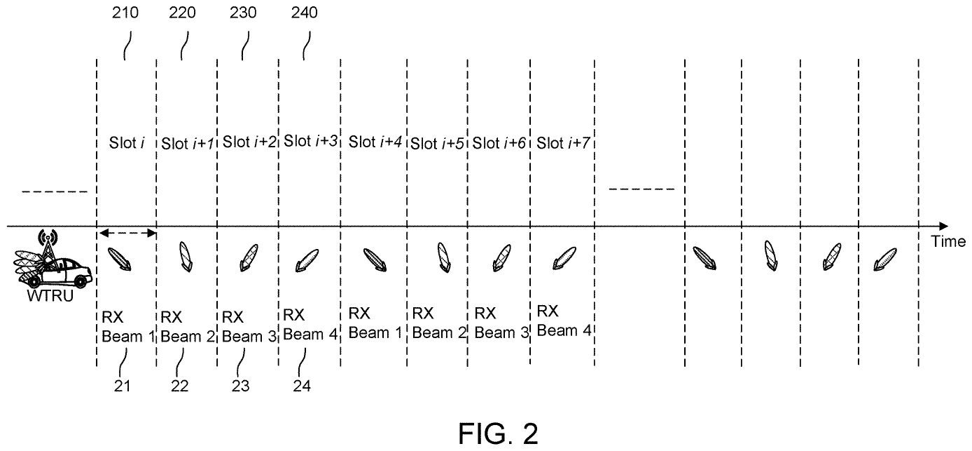

FIG. 2 depicts a receive beam periodic sweeping pattern. The beam pattern shown in FIG. 2, comprises four RX beams 21, 22, 23, 24 respectively associated with sets of periodic SL slots 210, 220, 230, 240.

A WTRU may use a different RX beam in a SL slot according to a RX beam pattern configuration. The configuration may include any of a number of RX beams (e.g., in the pattern), an indication of a (e.g., each) RX beam in the pattern, an indication of a TX beam corresponding to the (e.g., each) RX beam in the pattern, and an association between a RX beam and a set of periodic SL slots in a resource pool.

In an example, the configuration may include a number of RX beams in the pattern. The duration of the pattern may be the same as the number of RX beams in the pattern.

In an example, the configuration may include an indication of a (e.g., each) RX beam in the pattern. In one example shown in FIG. 2, the RX beam pattern may be [RX beam 1 (21), RX beam 2 (22), RX beam 3(23), RX beam 4 (24)].

In an example, the configuration may include an indication of a TX beam corresponding to the (e.g., each) RX beam in the pattern. A WTRU may determine a TX beam corresponding to a RX beam based on beam correspondence. In one example, a WTRU may indicate a mapping (e.g., association) between a RX beam and one or more TX beam(s) in the configuration, e.g., RX beam 1 corresponding to TX beam 1.

In an example, the configuration may include an association between a RX beam and a set of periodic SL slots in a resource pool. A WTRU may repeat the RX beam pattern (e.g., continuously) in a resource pool. For example, a RX beam may be applied in a set of periodic SL slots. A WTRU may indicate an association between a RX beam in the pattern and a set of SL slots in a resource pool. In one example, this association may be indicated using an index of the start slot of the RX beam pattern and the number of RX beams in the pattern. In the example in FIG. 2, the first RX beam 21 (referred to as RX beam 1) may be associated with SL slots when (e.g., for which) (the SL slot index-start slot index i) MOD (number of RX beams in the pattern) equals zero.

A WTRU may provide (e.g., transmit) its RX beam pattern configuration to a peer WTRU of a unicast SL, for example, in unicast establishment messages. In one example, a WTRU may dynamically adjust the RX beam patten based on at least the number of unicast SL receptions associated with a RX beam and the traffic pattern of a unicast SL. In one example, a WTRU may determine to remove a RX beam from a RX beam pattern if the RX beam is not associated with any unicast SL reception. In another example, a WTRU may repeat the same RX beam in a pattern to increase the number of the associated SL slots (thereby resources) if the RX beam is associated with a plurality of unicast SL receptions. In a further example, a WTRU may temporarily remove a RX beam during a traffic period of a unicast SL. A WTRU may indicate the adjusted RX beam pattern configuration to a peer WTRU of a unicast SL.

Applying a RX beam pattern and exchanging the configuration information between WTRUs of a unicast link may allow to provide a peer WTRU with a (e.g., known) reference regarding from which direction a WTRU may receive a SL transmission in a (e.g., given) SL slot such that the peer WTRU may determine a TX beam and resource configuration accordingly.

### Determination and Reporting of TX/RX Beam Pairs Associated with a Unicast SL

An example method for determining and reporting TX/RX beam pairs associated with a unicast SL is described herein.

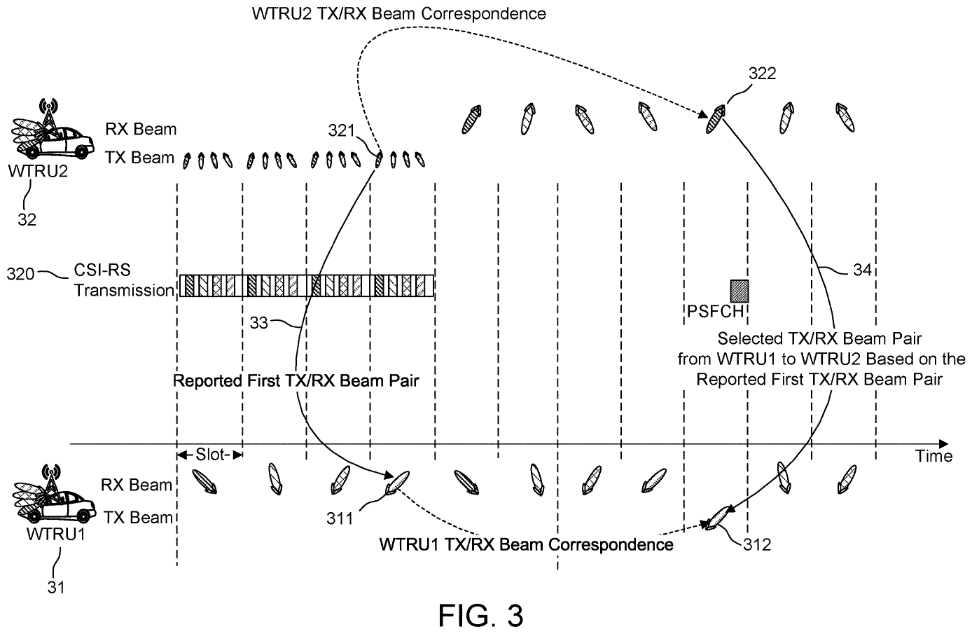

FIG. 3 is a diagram illustrating an example for determining and reporting of TX/RX beam pairs associated with a unicast SL. In an example, a first WTRU 31 (referred to as WTRU1) may receive a set of CSI-RS transmissions 320 from a second WTRU 32 (referred to as WTRU2). The set of CSI-RS transmissions 320 may be sent according to a RX beam pattern configuration, as described herein. The first WTRU 21 may determine first (e.g., active) beam pair 33 based on the received CSI-RS transmissions 320. The first (e.g., active, reported) beam pair 33 may comprise a Rx beam 311 of the first WTRU 31 and a TX beam 321 of the second WTRU 32. The first WTRU 31 may select a second beam pair 34 based on the first (e.g., active, reported) beam pair 33. The second beam pair 34 may comprise a TX beam 312 of the first WTRU 31 corresponding to the RX beam 311 of the first WTRU 31 in the first (e.g., active, reported) beam pair 33. The second beam pair 34 may comprise a RX beam 322 of the second WTRU 32 corresponding to the TX beam 321 of the second WTRU 32 in the first (e.g., active, reported) beam pair 33.

### TX/RX Beam Pair Determination for Unicast SL Based on CSI-RS Measurement

A WTRU may decode a sidelink control information (SCI) associated with a CSI-RS transmission from a peer WTRU of a unicast SL. The SCI associated with a CSI-RS transmission may include (e.g., indicate) one or more of (1) a TX beam indication, (2) a TX/RX beam pair reporting request, (3) any of a WTRU source ID and WTRU destination ID, (4) a CSI-RS resource allocation, and (5) a number of CSI-RS transmissions and/or an index of the CSI-RS transmission.

In an example, the TX beam indication may indicate a TX beam used for the associated CSI-RS transmission by the peer WTRU of the unicast SL.

In an example, the TX/RX beam pair reporting request may be (pre)configured to indicate a request to report TX/RX beam pair information for a TX/RX beam pair association with a unicast transmission. A (e.g., each) reported TX/RX beam pair may include an indication of a TX beam of the peer WTRU and an indication a RX beam of the reporting WTRU. In one example, a TX/RX beam pair report may include measurement result of a (e.g., each) reported TX/RX beam pair.

In an example, a WTRU may be (pre)configured with a pair of unidirectional source and destination IDs for a unicast link. A WTRU may consider the reported TX/RX beam pairs associated with a unicast SL from the peer WTRU identified by the indicated source and destination ID.

In an example, related to CSI-RS resource allocation, CSI-RS frequency resource may be (pre)configured, e.g., over one physical resource block (PRB) and/or one sub-channel, and the index of the frequency resource may be indicated in the resource allocation. A WTRU may perform Mode 2 resource selection to select a resource of multiple consecutive slots. In one example, a WTRU may apply symbol-based CSI-RS transmissions as shown in FIG. 3. A SCI associated with a (e.g., each) CSI-RS transmission may indicate the time resource in terms of number of symbols.

In an example, the number of CSI-RS transmissions may indicate a total number of CSI-RS transmissions performed for this TX/RX beam pair reporting request. In another example, an index of the slot including the last CSI-RS transmission may be indicated and a WTRU may determine the end of a set of CSI-RS transmissions based on the indicated slot index.

In various embodiments, a WTRU may perform a measurement on a (e.g., each detected) CSI-RS transmission 320. The measurement may include, e.g., any of layer 1 reference signal received power) L1-RSRP and LOS/NLOS measurement. For example, a (e.g., each) measurement may be specific to a TX/RX beam pair. The TX beam 321 may be the one indicated in the SCI associated with the measured CSI-RS transmission, e.g., the one used for the CSI-RS transmission. The RX beam 311 may be the one used to receive and measure the CSI-RS transmission.

A (e.g., first) WTRU 31 may determine a first TX/RX beam pair 33 to be designated as the active TX/RX beam pair associated with the unicast SL transmission from the peer (e.g., second) WTRU 32 based on the L1-RSRP measurement of the CSI-RS transmissions 320, for example satisfying a first strength condition. For example, a WTRU may select a TX/RX beam pair with the highest measured L1-RSRP (e.g., relative to other L1-RSRP measurements associated with other beam pairs) as the active TX/RX beam pair associated with a unicast SL transmission.

A WTRU may further determine one or more alternative TX/RX beam pair(s) associated with the unicast SL transmission from the peer WTRU based on at least one alternative L1-RSRP and/or LOS/NLOS measurement of the CSI-RS transmissions e.g., satisfying one or more conditions. In one example, a WTRU may determine one or more alternative TX/RX beam pair when any of (e.g., or both) of the following (e.g., strength, LOS/NLOS) conditions are met.

In a first example, the WTRU may determine one or more alternative TX/RX beam pair if the measured L1-RSRP of the TX/RX beam pair satisfies a second strength condition, such as, for example, exceeding a (pre)configured threshold. In another example, the WTRU may determine one or more alternative TX/RX beam pair if a delta value between L1-RSRP value of the TX/RX beam pair and the L1-RSRP value of the determined active TX/RX beam pair is smaller than or equal to a (pre)configured threshold.

In a second example, the WTRU may determine one or more alternative TX/RX beam pair if at least one LOS/NLOS measurement associated with the at least one alternative beam (e.g., the delta value between a measured LOS/NLOS value of the TX/RX beam pair and the measured LOS/NLOS value of the determined active TX/RX beam pair) satisfy a LOS/NLOS condition (e.g., is the highest among measured TX/RX beam pairs).

The conditions described herein may enable a WTRU to identify an alternative TX/RX beam pair, which may have a LOS/NLOS condition that may be uncorrelated with the active TX/RX beam pair. For example, the alternative TX/RX beam pair may have a NLOS propagation condition and the active TX/RX beam pair may have a LOS propagation condition. If the LOS propagation condition is blocked, the NLOS propagation condition may not be blocked, and e.g., may provide an alternative channel to continue transmission and recovery after the failure of the active TX/RX beam pair. If the active and alternative TX/RX beam pairs (e.g., both) have LOS propagation condition between the two WTRUs, the beam pairs may experience blockage at the same time and leave no alternative channel available for a recovery.

Reporting of TX/RX Beam Pair in a Physical Sidelink Feedback Channel (PSFCH) Transmission In an example, a WTRU may include indication of TX and RX beams of (e.g., all) determined active and alternative TX/RX beam pairs in a TX/RX beam pair report to a peer WTRU. In another example, a WTRU may determine a set of TX/RX beam pairs for reporting having measured L1-RSRP above a (pre)configured threshold. A WTRU may include indications of TX and RX beams of a (e.g., each) TX/RX beam pair and corresponding L1-RSRP and/or LOS/NLOS measurements in a TX/RX beam report. A WTRU may provide (e.g., absolute values of) L1-RSRP and/or LOS/NLOS measurements in the report. In another example, a WTRU may indicate the delta value of L1-RSRP and/or LOS/NLOS measurements of a (e.g., each) reported TX/RX beam pair relative to the TX/RX beam with the highest L1-RSRP.

In an example, a WTRU may transmit the report in a PSFCH transmission. For example, a PSFCH may include a (pre)configured sequence and/or bit fields to indicate the TX and RX beam indication of the active and alternative TX/RX beam pairs. In another embodiment, a WTRU may transmit the report in a PSSCH/PSCCH transmission, e.g., using MAC CE or radio resource control (RRC) signaling.

A WTRU may determine a TX/RX beam pair to use for transmissions to the peer WTRU based on the reported active TX/RX beam pair for transmissions from the peer WTRU. A WTRU may consider a TX beam corresponding to the best RX beam for receiving from a peer WTRU to be the best TX beam in which to transmit to the peer WTRU because of channel symmetry and beam correspondence. For example, a WTRU may determine to use a TX beam corresponding to the RX beam of the reported active TX/RX beam pair. The indication of this TX beam may be included in the WTRU's (e.g., own) RX beam pattern configuration.

Based on channel symmetry and beam correspondence, a WTRU may consider that the best RX beam of the peer WTRU to receive the PSFCH may be the RX beam of the peer WTRU corresponding to the TX beam of the reported active TX/RX beam pair used by the peer WTRU for transmissions from the peer WTRU to this WTRU. A WTRU may determine the indication of the RX beam of the peer WTRU based on the corresponding TX and RX beam indications in the RX beam pattern configuration received from the peer WTRU.

A WTRU may determine (e.g., select) a SL slot after the CSI-RS transmission (e.g., after the indicated slot including the last CSI-RS transmission) for placement of a PSFCH occasion, which may be the next (e.g., earliest) SL slot associated with the determined RX beam of the peer WTRU. A WTRU may determine the SL slot based on the association between SL slots and the RX beam in the RX beam pattern configuration received from the peer WTRU.

A WTRU may determine the PSFCH frequency resource based on the CSI-RS transmission resources. A WTRU may be (pre)configured with an implicit association between frequency resource of the CSI-RS transmission and corresponding PSFCH transmission. In one example, the association may be a one-to-one mapping where the same PRB and/or sub-channel may be applied for PSFCH transmission. In another example, the association may include a (pre)configured frequency offset.

### Determination of TX/RX Beam Pair associated with Unicast Transmission to the Peer WTRU

In one example, a WTRU may determine TX/RX beam pairs associated with unicast transmission to the peer WTRU based on the reported TX/RX beam pair information for transmissions from the peer WTRU. A WTRU may determine an active TX/RX beam pair for unicast SL transmission from a peer WTRU (to be included in the report) and (e.g., also) an active TX/RX beam pair for unicast SL transmission to a peer WTRU based on the same CSI-RS measurement.

In one example, a WTRU may determine an active TX/RX beam pair associated with a unicast SL to the peer WTRU based on the reported active TX/RX beam pairs for transmissions from the peer WTRU. A WTRU may associate the determined TX/RX beam pair for PSFCH transmission (described herein) as the active TX/RX beam pair associated with unicast transmissions to the peer WTRU.

A WTRU may determine one or more alternative TX/RX beam pair associated with unicast transmissions to the peer WTRU based on the reported alternative TX/RX beam pair(s) for transmissions from the peer WTRU. Based on channel symmetry and beam correspondence, the TX beam to be used for transmission to the peer WTRU may correspond to the RX beam of the reported TX/RX beam pair for transmissions from the peer WTRU, and a WTRU may determine the indication of this TX beam based on its own RX beam pattern configuration. The RX beam of an alternative TX/RX beam pair (of the peer WTRU) may correspond to the TX beam of the reported alternative TX/RX beam pair. A WTRU may determine the indication of this RX beam based on the reported TX beam indication and corresponding RX beam indication included in the RX beam pattern configuration from the peer WTRU.

In another example, a WTRU may perform a TX/RX beam pair report to request TX/RX beam pair reporting to determine TX/RX beam pairs associated with unicast transmission to the peer WTRU. This may be performed, e.g., when a WTRU does not support beam correspondence.

### Example Method for Beam Pair Determination and Reporting

In an example, a WTRU may receive a RX beam pattern configuration from a second WTRU of a unicast SL. For example, a RX beam pattern configuration may include any of a number of RX beams in the pattern, an indication of a (e.g., each) RX beam in the pattern, an indication of TX beam(s) corresponding to a (e.g., each) RX beam, an association between a RX beam and a set of periodic SL (e.g., logical) slots in a resource pool.

In an example, the WTRU may receive and measure a set of SL CSI-RS transmissions from the second WTRU. For example, SCI of a (e.g., each) CSI-RS transmission may include any of a TX beam indication, a TX/RX beam pair reporting request, a WTRU source identifier (ID) and a destination ID, etc. For example, measurement may include any of L1-RSRP and LOS/NLOS measurement of a (e.g., each) CSI-RS transmission.

In an example, the WTRU may determine (e.g., a first TX/RX beam pair as) an active TX/RX beam pair and one or more (e.g., TX/RX beam pair(s)) as alternative beam pair(s) associated with the unicast SL transmission from the second WTRU based on measured L1-RSRP and/or LOS/NLOS value.

In an example, the WTRU may determine a (e.g., PSFCH) occasion and a (e.g., PSFCH) TX beam. For example, the occasion may be the (e.g., PSFCH) occasion within a SL (e.g., logical) slot associated with the RX beam of the second WTRU corresponding to the TX beam of the determined active TX/RX beam pair based on the received RX beam pattern configuration. For example, the WTRU may using a TX beam corresponding to the RX beam of the determined active TX/RX beam pair.

In an example, the WTRU may transmit a (e.g., TX/RX) beam pair report (e.g., in a PSFCH) in the determined (e.g., PSFCH) occasion using the determined TX beam. For example, the (e.g., TX/RX) beam pair report may include (e.g., indicate) the determined active and alternative (e.g., TX/RX) beam pairs).

### Resource Selection Based on Reported TX/RX Beam Pair Associated with a Unicast SL

An example method for resource selection based on reported TX/RX beam pair associated with a unicast SL is described herein.

CSI-RS Transmissions to Request TX/RX Beam Pair Reporting A WTRU may (e.g., be triggered to) perform a set of CSI-RS transmissions to a peer WTRU of a unicast SL to request TX/RX beam pair reporting. The triggering conditions may include (e.g., be based on) one or more of (1) a (pre)configuration, (2) a time period since a last TX/RX beam pair reporting reception and/or association based on the reporting, (3) a SL measurement, (4) a sensing result, (5) a number of HARQ DTX and/or NACK, (6) a beam failure indication, and (7) a time period since last SL transmission and/or reception activities over the unicast SL.

In a first example, the WTRU may perform a set of CSI-RS transmissions to a peer WTRU of a unicast SL to request TX/RX beam pair reporting based on a (pre)configuration. A WTRU may be (pre)configured with a set of periodic TX/RX beam pair request configurations. In one example, the TX/RX beam pair request (pre)configurations may be based on a quality of Service (QOS) requirement of a unicast SL. A WTRU may perform more frequent TX/RX beam pair request for a unicast SL for transmissions of transport blocks (TBs) of higher priority.

In a second example, the WTRU may perform a set of CSI-RS transmissions to a peer WTRU of a unicast SL to request TX/RX beam pair reporting based on a time period since a last TX/RX beam pair reporting reception and/or an association based on the reporting. A WTRU may associate TX/RX beam pairs reported by a peer WTRU as active and alternative TX/RX beam pairs with unicast SL transmissions to the peer WTRU. A WTRU may be (pre)configured with a set of time periods for the associations based on the QoS requirement of the associated unicast SL, e.g., priority of the TBs. An association for higher priority unicast link may be (pre)configured with a shorter time period. A WTRU may perform TX/RX beam pair request when the time period since last TX/RX beam pair reporting reception and/or association based on the reporting exceeds a time period (pre)configured for the associated unicast SL.

In a third example, the WTRU may perform a set of CSI-RS transmissions to a peer WTRU of a unicast SL to request TX/RX beam pair reporting based on a SL measurement. A WTRU may perform a SL measurement using the RX beam of one active TX/RX beam pair associated with unicast SL transmissions to a peer WTRU. The measurement may include SL CBR, SL RSSI, SL RSRP and/or SL channel quality indicator (CQI). A WTRU may perform TX/RX beam pair request when the SL measurement may be higher (e.g., SL channel busy rate (CBR), SL received signal strength indicator) (RSSI) or lower (e.g., SL RSSI, SL CQI) than a (pre)configured corresponding threshold.

In a fourth example, the WTRU may perform a set of CSI-RS transmissions to a peer WTRU of a unicast SL to request TX/RX beam pair reporting based on a sensing result. A WTRU may perform a Mode 2 sensing using the RX beam of one active TX/RX beam pair associated with unicast SL transmissions to a peer WTRU. A WTRU may perform TX/RX beam pair request when one or more sensing results (e.g., number of RSRP increments, measured RSRPs of reservation associated with the available and/or selected candidate resources, measured RSSI of the available and/or selected candidate resources) is higher than a (pre)configured corresponding threshold. An available and/or selected candidate resources with the higher measurement may experience higher interference.

In a fifth example, the WTRU may perform a set of CSI-RS transmissions to a peer WTRU of a unicast SL to request TX/RX beam pair reporting based on a number of HARQ-DTX and/or HARQ-NACK. A WTRU may perform TX/RX beam pair request when the number of received HARQ DTX/NACK exceeds a (pre)configured threshold. The (pre)configuration may be associated with QoS requirements of the unicast SL, e.g., the priority of the TBs. A WTRU may consider a HARQ DTX to have occurred when the WTRU does not receive a PSFCH (e.g., HARQ) corresponding to a PSSCH/PSCCH transmission.

In a sixth example, the WTRU may perform a set of CSI-RS transmissions to a peer WTRU of a unicast SL to request TX/RX beam pair reporting based on a beam failure indication. A WTRU may perform TX/RX beam pair request when a beam failure of the unicast SL is determined (e.g., occurs).

In a seventh example, the WTRU may perform a set of CSI-RS transmissions to a peer WTRU of a unicast SL to request TX/RX beam pair reporting based on a time period since last SL transmission and/or reception activities over the unicast SL. In one example, the SL activities may entail a reception of unicast SL measurement from the peer WTRU, e.g., SL CQI. In one example, a WTRU may be (pre)configured with a set of time periods for CQI reporting associated with QoS/priority of the unicast SL. A shorter CQI time period may, for example, be (pre)configured for a unicast SL with higher priority. A WTRU may perform TX/RX beam pair request when the time period since last reception of a unicast SL measurement, e.g., SL CQI, exceeds a time period e.g., (pre)configured for the unicast SL. In another example, the SL activities may be a PSSCH/PSCCH transmission to a peer WTRU and/or a PSSCH/PSCCH reception from a peer WTRU over the unicast SL. Depending on traffic pattern, a WTRU may not transmit and/or receive over a unicast SL for a period of time. A WTRU may, for example, perform TX/RX beam pair request when the time period since the last transmission and/or reception of a unicast SL exceeds a time period (pre)configured for the unicast SL. The (pre)configured threshold may be associated with the QoS/priority of the unicast SL.

A WTRU may determine the number of CSI-RS transmissions to be performed based on the number of RX beams indicated in the RX beam pattern configuration of the peer WTRU (which may be referred to as N) and the number of TX beams the WTRU may apply for the unicast SL transmission (which may be referred to as M).

A WTRU may indicate at least one of the following pieces of information in the SCI associated with a (e.g., each) CSI-RS transmission to a peer WTRU of a unicast SL.

In a first example, the SCI may indicate a TX beam indication. The WTRU may include an indication of the TX beam used for the associated CSI-RS transmission, which may be reported in a TX/RX beam pair report.

In a second example, the SCI may indicate a TX/RX beam pair reporting request. The WTRU may include an indication to request a TX/RX beam pair reporting.

In a third example, the SCI may indicate any of WTRU source ID and a WTRU destination ID. The WTRU may indicate any of the WTRU source ID and the WTRU destination ID (pre)configured for the data (PSSCH/PSCCH) transmission of the unicast SL to the peer WTRU.

In a fourth example, the SCI may indicate a CSI-RS resource allocation. The WTRU may indicate the CSI-RS frequency resource, e.g., index of PRB(s) and/or sub-channel(s). In another example, the WTRU may indicate the number of symbols and starting symbol of a CSI-RS transmission in a SL slot. For example, a WTRU may indicate one or more resources reserved for the next CSI-RS transmissions.

In a fifth example, the SCI may indicate a number of CSI-RS transmissions. A WTRU may indicate the performed number of CSI-RS transmissions, e.g., M*N to be measured for the beam pair reporting request. In another example, the WTRU may indicate the index of the slot including the last CSI-RS transmission.

In a sixth example, the SCI may indicate an index of the CSI-RS transmission. The WTRU may indicate an index of, for example, each CSI-RS transmission.

A WTRU may perform a Mode 2 resource selection to select resources in a set of multiple consecutive SL slots, e.g., M*N resources. A WTRU may perform a CSI-RS transmission in a (e.g., each) selected resource using a determined TX beam indicated by the TX beam indication included in the SCI associated with the CSI-RS transmission.

### Association between Reported TX/RX Beam Pairs with Unicast Transmission to the Peer WTRU Performing the TX/RX Beam Pair Reporting

A WTRU may receive a TX/RX beam pair report including a first TX/RX beam pair designated (e.g., indicated) as active TX/RX beam pair and one or more TX/RX beam pair(s) designated (e.g., indicated) as alternative TX/RX beam pair(s), and the (e.g., each) beam pair may include an indication of the TX beam of the WTRU and indication of the RX beam of the peer WTRU. A WTRU may associate the reported TX/RX beam pairs as indicated active and alternative TX/RX beam pairs with the unicast transmission to the peer WTRU.

In another example, a WTRU may receive a set of TX/RX beam pairs and corresponding measurement results, e.g., L1-RSRP and/or LOS/NLOS measurement in the report. A WTRU may determine one or more TX/RX beam pair(s) with the highest L1-RSRP value(s) as the active TX/RX beam pair(s) associated with the unicast SL transmissions to the reporting peer WTRU. A WTRU may determine one or more TX/RX beam pair(s) as alternative TX/RX beam pairs based on the delta LOS/NLOS value between a TX/RX beam and a determined active TX/RX beam pair. In one example, a WTRU may determine one or more TX/RX beam pair(s) with the largest LOS/NLOS delta value as alternative TX/RX pair(s).

A WTRU may perform the unicast SL (e.g., PSSCH/PSCCH) transmission to the peer WTRU using the information of the associated active TX/RX beam(s). A WTRU may perform beam failure detection and recovery using the information of the associated active and alternative TX/RX beam pairs.

A WTRU may associate the reported and/or determined TX/RX beam pairs with a unicast SL transmission to the peer WTRU reporting the TX/RX beam pair information. This associated unicast SL may be identified by a pair of source and destination WTRU IDs. In an example, the pair of WTRU IDs may be (pre)configured by a higher layer and may be unidirectional. The pair of WTRU IDs may apply to transmission from the WTRU with source ID to the peer WTRU with destination ID.

A peer WTRU of the same unicast SL may be (pre)configured with another pair of WTRU source and destination IDs to identify the unicast SL transmission from the peer WTRU. For example, a peer WTRU may perform an identical TX/RX beam pair reporting request to determine TX/RX beam pairs associated with a corresponding pair of WTRU source and destination IDs. In another example, as described herein, a peer WTRU may determine the RX beam pairs associated with the same unicast SL with opposite direction based on the performed TX/RX beam reporting. This may be applicable with channel symmetry and beam correspondence.

In an example, a WTRU with a source WTRU ID for a unicast SL may determine and maintain an association between TX/RX beam pairs and unicast transmissions to the peer WTRU with a destination ID. The peer WTRU of the unicast SL may perform the same procedures for unicast transmissions in the opposite direction identified by a corresponding pair of source and destination WTRU IDs. In one example, a WTRU may be informed by higher layers that two pairs of source and destination WTRU IDs may correspond to each other, e.g., the source WTRU in one pair may be the destination WTRU in the other pair.

If a WTRU does not receive a PSFCH corresponding to CSI-RS transmission performed for TX/RX beam reporting, a WTRU may indicate link failure to higher layers.

### Resource Selection Based on an Active TX/RX Beam Pair Associated with Unicast SL Transmissions to a Peer WTRU

A WTRU may (e.g., be triggered to) perform a data (e.g., PSSCH/PSCCH) transmission to a peer WTRU of a unicast SL associated with TX/RX beam pairs received in TX/RX beam pair report. In one example, a WTRU may perform a Mode 2 resource selection (sensing) using a RX beam corresponding to the TX beam of the active TX/RX beam pair associated with the unicast SL transmission to the peer WTRU. A WTRU may determine a set of selectable candidate resources within a resource selection window and the selectable candidate resources may be within the SL slots associated with the RX beam of active TX/RX beam pair associated with the unicast SL transmission to the peer WTRU. A WTRU may determine the location of the SL slots based on the indication of the RX beam and the association between SL slots and RX beams in the RX beam pattern configuration received from the peer WTRU.

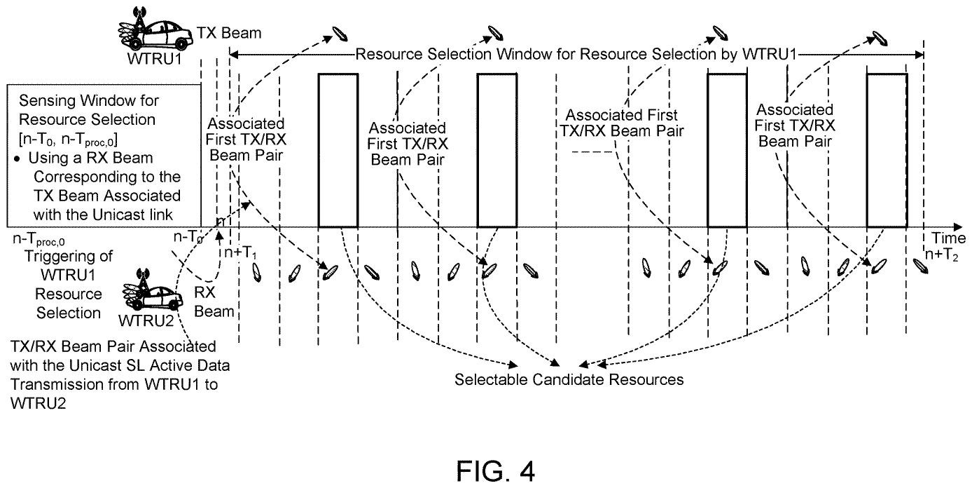

FIG. 4 is a diagram depicting an example method for resource selection for a unicast SL transmission based on associated TX/RX beam pair. In the example shown in FIG. 4, the selectable candidate resources may be within the slots associated with the RX beam of the peer WTRU that may receive the unicast SL transmission. For example, with the received RX beam pattern configuration from the peer WTRU, a WTRU may have prior knowledge about which RX beam a peer WTRU may use in any (e.g., given) SL slot. Accordingly, a WTRU may use this knowledge to identify SL slots in which the (e.g., desired) RX beam, e.g., the RX beam of the TX/RX beam pair associated with PSSCH/PSCCH transmission to the peer WTRU, may be used. A WTRU may subsequently perform resource selection within the resources located in the identified SL slots. A WTRU may perform a PSSCH/PSCCH transmission of the unicast SL using the TX beam of the associate active TX/RX beam pair in selected resource(s).

### WTRU Performing Unicast Data (Re)Transmissions using Different Associated TX/RX Beam Pairs

In an example, a WTRU may determine to apply different associated TX/RX beam pair(s) for unicast PSSCH/PSCCH re-transmissions. In one example, a WTRU may determine to use one or more alternative TX/RX beam pairs. In another example, a WTRU may determine to use a different active TX/RX beam pair associated with the unicast transmissions. The determination may be based one or more of the following examples.

In a first example, a WTRU may determine to apply a different associated TX/RX beam pair for a re-transmission when the WTRU receives one or more HARQ NACK and/or DTX corresponding to a PSSCH/PSCCH transmission using an active TX/RX beam pair.

In a second example, the determination may be based on a sensing result. A WTRU may perform one or more transmissions of a TB using an active TX/RX beam pair and determine to apply different TX/RX beam pair(s) associated with the same unicast SL based on the results of the sensing (e.g., resource selection) performed for the transmission(s). In one example, a WTRU may perform such TX/RX beam re-selection for re-transmission(s) when one or more sensing results (e.g., any of a number of RSRP increments, measured RSRPs of reservation associated with the available and/or selected candidate resources, measured RSSI of the available and/or selected candidate resources) is higher than a (pre)configured corresponding threshold.

### Example Method for Resource Selection Based on Reported TX/RX Beam Pair Associated with a Unicast SL

In an example, a WTRU may receive a RX beam pattern configuration from a second WTRU of a unicast SL. For example, a RX beam pattern configuration may include any of a number of RX beams (e.g., in the pattern), an indication of a (e.g., each) RX beam in the pattern, an indication of TX beam(s) corresponding to the (e.g., each) RX beam, and an association between a RX beam and a set of periodic SL (e.g., logical) slots in a resource pool.

In an example, the WTRU may transmit a set of SL CSI-RS transmissions to the second WTRU when one or more of the following conditions are met. For example, the WTRU may transmit a set of SL CSI-RS transmissions based on any of (1) being (pre)configured with a periodic CSI-RS transmissions, (2) determining a beam failure, (3) being (pre)configured with a periodicity, (4) the number of received HARQ NACK/DTX from the peer WTRU exceeding a threshold, (5) the WTRU measuring a CBR higher than a threshold, (6) a measured channel condition, e.g., RSRP or RSSI, lower or higher than a threshold, and (7) a time period since the last TX/RX beam pair reporting and/or CQI reporting reception exceeding a threshold.

In an example, the WTRU may transmit CSI-RS transmissions using multiple TX beams. For example, SCI of a (e.g., each) CSI-RS transmission may include any of a TX beam indication, a TX/RX beam pair reporting request, a WTRU source ID and a WTRU destination ID, etc.

In an example, the WTRU may receive a TX/RX beam pair report from the second WTRU e.g., in a PSFCH and may associate indicated active and alternative TX/RX beam pairs with the unicast transmissions to the reporting peer WTRU.

In an example, the WTRU may perform resource selection in a set of selectable candidate slots e.g., in a resource selection window for a unicast transmission to the second WTRU. For example, the selectable candidate slots may be SL (e.g., logical) slots associated with the RX beam of active TX/RX beam pair associated with unicast transmissions to the second WTRU.

In an example, the WTRU may transmit a unicast (e.g., PSSCH/PSCCH) transmission using the TX beam of the active TX/RX beam pair to the second WTRU in a selected resource.

### SL Beam Failure Detection and Recovery

An example method for beam failure detection and recovery is described herein.

### WTRU Determination to Perform SL Beam Failure Detection and Recovery

In an example, a WTRU may (e.g., be triggered to) perform a SL beam failure detection for a unicast SL. The (e.g., triggering) conditions may include one or more of the following examples.

In a first example, the WTRU may perform a SL beam failure detection based on a (pre)configuration. A WTRU may be (pre)configured with a set of periodic SL beam failure detection configurations. In one example, a beam failure detection (pre)configuration may be based on QoS requirement of a unicast SL. A WTRU may perform more frequent beam failure detection for a unicast SL for transmissions of TBs of higher priority.

In a second example, the WTRU may perform a SL beam failure detection based on a time period since a last TX/RX beam pair reporting reception and/or association based on the reporting. A WTRU may be (pre)configured with a set of time periods for TX/RX beam pair associations based on the QoS requirement of the associated unicast SL, e.g., priority of the TBs. An association for higher priority unicast link may be (pre)configured with a shorter time period. A WTRU may perform beam failure detection to check the beam link quality when the time period since last TX/RX beam pair reporting reception and/or association based on the reporting exceeds a time period (pre)configured for the associated unicast SL.

In a third example, the WTRU may perform a SL beam failure detection based on SL measurement. A WTRU may perform a SL measurement using the RX beam of the active TX/RX beam pair associated with unicast transmissions to a peer WTRU. The measurement may include any of SL CBR, SL RSSI, SL RSRP, and SL CQI. A WTRU may perform beam failure detection when the SL measurement is higher (e.g., SL CBR, SL RSSI) or lower (e.g., SL RSSI, SL CQI) than a (pre)configured corresponding threshold. In another example, the thresholds may be associated with a QoS requirement of the unicast SL and/or priority of the unicast SL TBs.

In a fourth example, the WTRU may perform a SL beam failure detection based on a sensing result. A WTRU may perform a Mode 2 sensing using the RX beam of an active TX/RX beam pair associated with unicast SL transmissions to a peer WTRU. A WTRU may perform beam failure detection when one or more sensing results (e.g., any of a number of RSRP increments, measured RSRPs of reservation associated with the available and/or selected candidate resources, measured RSSI of the available and/or selected candidate resources) is higher than a (pre)configured corresponding threshold.

In a fifth example, the WTRU may perform a SL beam failure detection based on a number of HARQ DTX and/or HARQ-NACK. A WTRU may perform beam failure detection when the number of received HARQ DTX/NACK exceeds a (pre)configured threshold. The (pre)configuration may be associated with QoS requirement of the unicast SL and/or the priority of the unicast TBs. A WTRU may consider a HARQ DTX to have occurred when the WTRU does not receive a PSFCH corresponding to a PSSCH/PSCCH transmission.

In a sixth example, the WTRU may perform a SL beam failure detection based on a number of re-transmissions of a TB performed over the unicast SL. A WTRU may perform beam failure detection when the re-transmissions of a TB performed over the unicast SL exceeds a (pre)configured threshold. In another example, a WTRU may be (pre)configured with a (e.g., maximum) number of TBs and when the number is reached, a WTRU may perform beam failure detection.

In a seventh example, the WTRU may perform a SL beam failure detection based on a time period since last reception of unicast SL measurement, e.g., SL CQI. A WTRU may perform beam failure detection when the time period since the last reception of a unicast SL measurement, e.g. SL CQI, exceeds a time period (pre)configured for the unicast SL.

In an eighth example, the WTRU may perform a SL beam failure detection based on a time period since last data transmission and/or reception of a unicast SL. Depending on traffic patterns, a WTRU may not transmit and/or receive over a unicast SL for a period of time. A WTRU may perform beam failure detection when the time period since the last transmission and/or reception of a unicast SL exceeds a time period (pre)configured for the unicast SL. The (pre)configured threshold may be associated with the QoS requirement and/or priority of TBs of the unicast SL.

### WTRU Performing CSI-RS Transmission for Beam Failure Detection for TX/RX Beam Pairs Associated with a Unicast SL

(E.g., when triggered) a WTRU may determine to perform a set of CSI-RS transmissions for beam failure detection for a unicast SL. In one example, a WTRU may determine one set of CSI-RS transmissions using the TX beam of an active TX/RX beam pair and one or more set(s) of CSI-RS transmissions using TX beam(s) of one or more alternative TX/RX beam pair(s) associated with unicast transmissions to a peer WTRU. A WTRU may be (pre)configured with a number of CSI-RS transmissions (referred to as N) in a CSI-RS transmission set. The number N of CSI-RS transmissions may allow a peer WTRU to measure and determine a beam failure and to avoid parasite (e.g., unnecessary) beam failure detection caused by short-term channel variation within the TX/RX beam pair.

A WTRU may indicate at least the following information in the SCI associated with a (e.g., each) CSI-RS transmission to a peer WTRU for beam failure detection of a unicast SL.

In an example, the SCI may include a TX beam indication. A TX beam indication may indicate a TX beam used for the associated CSI-RS transmission. Based on the indication, a peer WTRU may determine a corresponding RX beam used by the WTRU and thereby associated SL slots to transmit a PSFCH.

In an example, the SCI may indicate a beam failure detection request. A WTRU may include an indication to request a beam failure detection, which may be a different type measurement compared to CSI-RS transmissions for TX/RX beam pairing.

In an example, the SCI may indicate a WTRU source ID and a WTRU destination ID. A WTRU may indicate the WTRU source and destination ID of the unicast SL pertaining to the beam failure detection.

In an example, the SCI may indicate a CSI-RS resource allocation. A WTRU may indicate the CSI-RS frequency resource, e.g., index of PRB(s) and/or sub-channel(s). For beam failure detection, a WTRU may perform a slot-based CSI-RS transmission, e.g., to use repetition of CSI-RS symbols using one TX beam in a slot. For example, a WTRU may indicate one or more resources reserved for the next CSI-RS transmissions.

In an example, the SCI may indicate a number of CSI-RS transmissions. A WTRU may indicate the performed number of CSI-RS transmissions, e.g., N, to be evaluated for the beam failure detection. In another example, a WTRU may indicate the index of the slot including the last CSI-RS transmission.

In an example, the SCI may indicate an index of the CSI-RS transmission. A WTRU may indicate an index of a (e.g., each) CSI-RS transmission.

A WTRU may perform a Mode 2 resource selection to select N resources for each set of CSI-RS transmission using one TX beam. A WTRU may perform a CSI-RS transmission in a (e.g., each) selected resource using the TX beam of TX/RX beam pair intended for the beam failure detection.

### WTRU Determination of Beam Failure Detection Based on Reception Status of PSFCHs Corresponding to the Performed CSI-RS Transmissions

In one example, a WTRU may perform the determined CSI-RS transmission sets in parallel, e.g., the transmission of one set of CSI-RS may not be conditioned on (e.g., be independent from) the transmission and result of another set of CSI-RS. A WTRU may determine a beam failure detection based on the reception status of PSFCHs corresponding to (e.g., all) the transmitted CSI-RS.

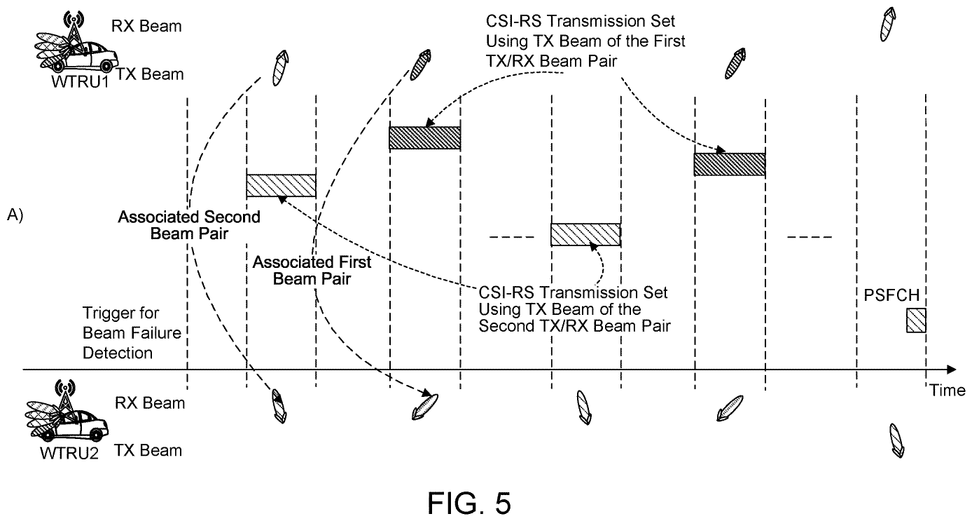

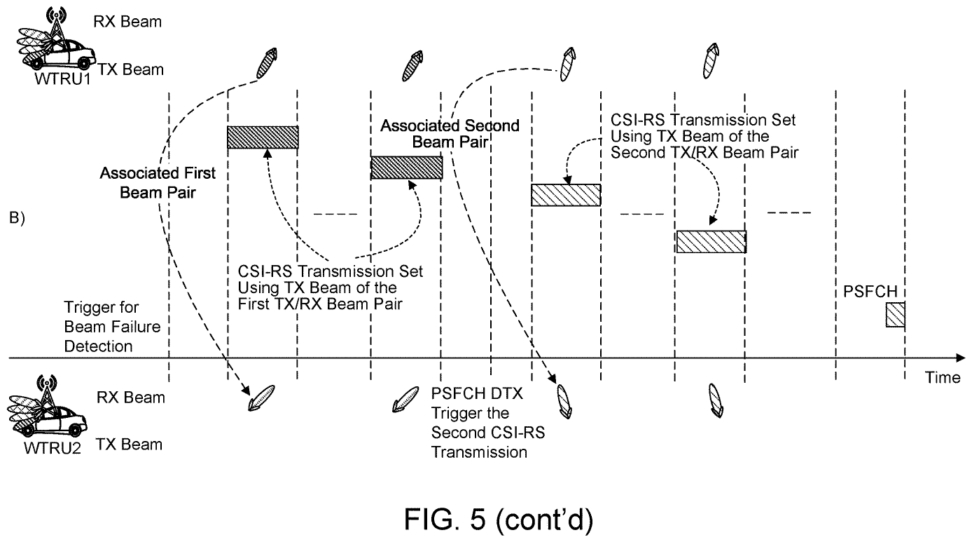

FIG. 5 is a diagram depicting an example method for CSI-RS transmissions for beam failure detection. In one example (e.g., example A in FIG. 5), a WTRU may perform two sets of CSI-RS transmissions for beam failure detection in parallel. A WTRU may perform one set of CSI-RS transmissions using the TX beam of the active (e.g. first) TX/RX beam pair and another set of CSI-RS transmissions using the TX beam of an alternative (e.g., second) TX/RX beam pair. In another example, a WTRU may perform one set of CSI-RS transmissions using the TX beam of the active TX/RX beam pair and multiple sets of CSI-RS transmissions (e.g., each) using the TX beam of an alternative TX/RX beam pair.

A WTRU may monitor a set of PSFCHs for beam failure detection including a PSFCH corresponding to a set (e.g., each set) of CSI-RS transmissions, and may determine a result of a beam failure detection. A WTRU may determine that no beam failure is detected when a WTRU detects (e.g., all) PSFCHs in the monitored PSFCH set. A PSFCH sequence may be (pre)configured to be transmitted in a PSFCH for beam failure detection and a WTRU may that determine a PSFCH is detected when such a sequence is de-correlated/decoded and received in the monitored PSFCH resource. In the example shown in FIG. 5, a WTRU may determine that no beam failure is detected when a WTRU detects two PSFCHs corresponding to the two sets of performed CSI-RS transmission.

A WTRU may determine that a partial beam failure has occurred when the WTRU detects a sub-set of corresponding PSFCHs. In one example, a WTRU may detect a partial beam failure when one or more of the following conditions is met. For example, the WTRU may detect a partial beam failure if a PSFCH corresponding to CSI-RS transmission set using the TX beam of the active TX/RX beam pair is not detected, and/or one or more PSFCH(s) corresponding to CSI-RS transmission set(s) using TX beam of alternative TX/RX beam pair(s) is detected.

When a WTRU detects a partial beam failure, the WTRU may perform a TX/RX beam association switch for a unicast link. For example, a WTRU may re-associate an alternative TX/RX beam pair (of which the corresponding PSFCH may be received) as the active TX/RX beam pair of the unicast SL for continued PSSCH/PSCCH transmissions. In one example, when multiple alternative TX/RX beam pairs are available for re-association, a WTRU may determine the TX/RX beam pair with the highest reported L1-RSRP to be the active TX/RX beam pair.

When a WTRU detects a PSFCH corresponding to CSI-RS transmission set using the TX beam of the active TX/RX beam pair and does not detect a PSFCH corresponding to any CSI-RS transmission set using the TX beam of any alternative TX/RX beam pair(s), a WTRU may (e.g., determine to) perform a TX/RX beam pair reporting request.

A WTRU may determine that a full beam failure may be detected when the WTRU does not detect any corresponding PSFCHs in the monitored PSFCH set. A WTRU may (e.g., be triggered to) perform a TX/RX beam pair reporting request and may indicate a beam failure to a higher layer when a (e.g., full) beam failure is detected. The higher layer may stop data transmission for the unicast SL to avoid HARQ DTX which may result in radio link failure.

In another example, a WTRU may perform a first set of CSI-RS transmissions using one TX beam and may determine whether or not to transmit a second set of CSI-RS transmission based on the PSFCH reception status corresponding to the first set of CSI-RS transmissions.

In another example (e.g., example B in FIG. 5), a WTRU may perform a first set of CSI-RS transmissions for beam failure detection using the TX beam of the active (e.g., first) TX/RX beam pair associated with the unicast SL. If a WTRU does not detect a corresponding PSFCH, the WTRU may determine to perform a second set of CSI-RS transmissions for beam failure detection using one alternative (e.g., second) TX/RX beam pair associated with the unicast SL. If the WTRU does not (e.g., subsequently) detect a corresponding PSFCH, a WTRU may determine to continue with another set of CSI-RS transmissions using the TX beam of one of the remaining alternative (e.g., second) TX/RX beam pair.

When there is more than one alternative (e.g., second) beam pair, the WTRU may randomly select an alternative TX/RX beam pair. In another example, the WTRU may select an alternative (e.g., second) TX/RX beam pair satisfying a condition (e.g., with the highest measured L1-RSRP, e.g., relative to other measured L1-RSRP). The WTRU may stop CSI-RS transmission for beam failure detection when a PSFCH is detected or no PSFCH is detected for (e.g., all) the sequential CSI-RS transmissions using TX beams of (e.g., all) alternative TX/RX beam pairs.

A WTRU may determine a partial beam failure to have occurred if the WTRU receives a PSFCH corresponding to one performed set of CSI-RS transmissions using the TX beam of an alternative (e.g., second) TX/RX beam. The WTRU may perform a TX/RX beam association switch for the unicast link. The WTRU may re-associate an alternative TX/RX beam pair (of which the corresponding PSFCH may be received) as the active TX/RX beam pair of the unicast SL for continued PSSCH/PSCCH transmissions.

A WTRU may determine a (e.g., full) beam failure to have occurred if the WTRU does not receive PSFCH corresponding to the any performed set of CSI-RS transmissions. The WTRU may (e.g., be triggered to) perform a TX/RX beam pair reporting request when a (e.g., full) beam failure is detected. The WTRU may indicate a beam failure to a higher layer such that the higher layer may stop data transmission for the unicast SL to avoid HARQ DTX, which may result in radio link failure.

### WTRU Determination of Transmission of PSFCH for Beam Failure Detection Based on Received CSI-RS Transmissions

In an example, a WTRU may decode a SCI associated with a CSI-RS transmission from a peer WTRU of a unicast SL. The WTRU may determine to measure a received CSI-RS transmission for beam failure detection based on the beam failure detection request indication included in the SCI.

In an example, a WTRU may measure L1-RSRP of a (e.g., each) received CSI-RS transmission. A WTRU may evaluate a beam failure event for a (e.g., each) received CSI-RS transmission based on L1-RSRP measurement of the CSI-RS transmission. In one example, the WTRU may determine to count a beam failure event when the measured L1-RSRP is below a (pre)configured threshold. For example, the WTRU may evaluate a beam failure after a measurement of the last CSI-RS transmission indicated in the SCI. If the (e.g., total) count of beam failure events is below a (pre)configured threshold, the WTRU may perform a PSFCH transmission to indicate no beam failure using a (pre)configured PSFCH sequence. In one example, the threshold may be (pre)configured as a ratio relative to the number of (e.g., total) CSI-RS transmissions indicated in the SCI. If the (e.g., total) count of beam failure events is larger than or equal to the (pre)configured threshold, the WTRU may determine not to perform a PSFCH transmission such that a PSFCH DTX may be detected by the peer WTRU.

A WTRU may determine a PSFCH occasion based on the indicated last CSI-RS transmission and the SL slot associated with the RX beam corresponding to the TX beam indicated in the SCI associated with the CSI-RS transmission. In one example, the WTRU may determine a PSFCH occasion in an (e.g., earliest) associated SL slot after the (e.g., last) CSI-RS transmission. The WTRU may determine the PSFCH frequency resource based on the (e.g., last) CSI-RS transmission resources. The WTRU may be (pre)configured with an (e.g., implicit) association between frequency resource of the CSI-RS transmission and corresponding PSFCH transmission. In one example, the association may be a one-to-one mapping where the same PRB and/or sub-channel may be applied for PSFCH transmission. In another example, the association may include a (pre)configured frequency offset.

### Example Method for SL Beam Failure Detection and Recovery

In an example, a WTRU may trigger performance of beam failure detection of a unicast SL when one or more of the following conditions is met. In a first example, the WTRU may perform beam failure detection of the unicast SL, if the WTRU is (pre)configured with a periodic beam failure detection. In a second example, the WTRU may perform beam failure detection of the unicast SL if the number of received HARQ DTX from the peer WTRU exceeds a threshold. In a third example, the WTRU may perform beam failure detection of the unicast SL if the WTRU measures a CBR higher than a threshold. In a fourth example, the WTRU may perform beam failure detection of the unicast SL. In a fifth example, the WTRU may perform beam failure detection of the unicast SL if a measured channel condition, e.g., any of RSRP and RSSI, is lower or higher than a threshold. In a sixth example, the WTRU may perform beam failure detection of the unicast SL if time period since last PSSCH/PSCCH transmission of the unicast SL, TX/RX beam pair reporting, and/or CQI reporting reception exceeds a threshold.

In an example, the WTRU may transmit a first set of SL CSI-RS transmissions using the TX beam of the active TX/RX beam pair and a second set of SL CSI-RS transmissions using the TX beam of the alternative TX/RX beam pair associated with the unicast transmissions to a peer WTRU. For example, SCI of a (e.g., each) CSI-RS transmission may include any of a TX beam indication, a beam monitoring indication, a WTRU source ID and a WTRU destination ID, etc.

In an example, the WTRU may determine (e.g., whether) a beam failure (e.g., occurred) based on detection of a first PSFCH corresponding to the first and (e.g., detection of) a second PSFCH corresponding to the second set of performed CSI-RS transmissions. For example, no beam failure may be determined if the first PSFCH is detected. For example, partial beam failure may be determined if the first PSFCH is not detected and the second PSFCH is detected. For example, (e.g., full) beam failure is determined if neither PSFCH is detected (e.g., first PSFCH not detected and second PSFCH not detected).

If beam failure is determined, the WTRU may trigger SL-CSI transmissions to request TX/RX beam pair reporting. For example, if partial beam failure is determined, the WTRU may re-associate the alternative TX/RX beam pair as active TX/RX beam pair of the unicast SL for continued PSSCH/PSCCH transmissions. For example, if (e.g., full) beam failure is determined, the WTRU may indicate the beam failure to higher layers.

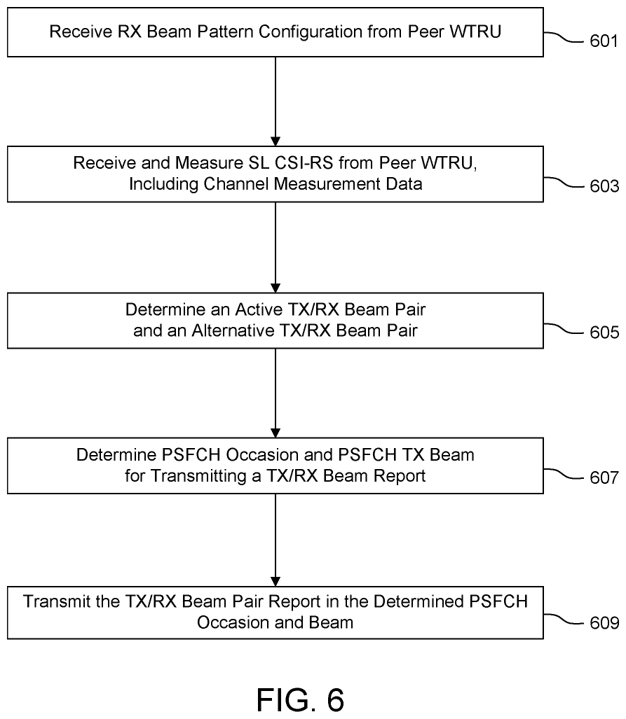

FIG. 6 is a flowchart illustrating an exemplary process for determining at least one TX/RX beam pair for communicating with a second WTRU via sidelink (SL) by determining beamforming parameters for sidelink operation by determining and reporting transmit/receive beam pairs associated with a unicast sidelink. The exemplary process may be implemented in a first WTRU. The first WTRU may include circuitry including any of transmitter, a receiver, a processor, and a memory.

As shown at 601, a WTRU participating in sidelink communications with a second, peer WTRU may receive an RX beam pattern configuration from the second WTRU.

As shown at 603, the WTRU may receive and measure a set of SL CSI-RS from the second WTRU, wherein the SL CSI-RSs may include channel measurement data (e.g., “data” on which measurement may be to be performed).

As shown at 605, the WTRU may determine a first TX/RX beam pair to be an active TX/RX beam pair and at least one alternative TX/RX beam pair based on the measurement data (e.g., based on measurement performed on the SL CSI-RS).

As shown at 607, the WTRU may determine a PSFCH occasion and PSFCH TX beam to be used for transmitting a TX/RX beam pair report to the second WTRU.

As shown at 609, the WTRU may transmit the TX/RX beam pair report in the determined PSFCH occasion and (e.g., using the) determined PSFCH beam.

In various embodiments, the received RX beam pattern configuration may comprise (e.g., indicate) any of a number of beams in the RX beam pattern, an indication of TX beams corresponding to a (e.g., each) RX beam, and an association between a (e.g., each) RX beam in the beam pattern configuration and a set of periodic SL (e.g., logical) slots in a resource pool.

In various embodiments, the CSI-RS from the second WTRU may comprise SCI, including at least one of a TX beam indication, a TX/RX beam pair reporting request, a WTRU source ID, a WTRU destination ID.

In various embodiment, the measurement (e.g., data) may comprise any of L1-RSRP data and LOS/NLOS measurements of each CSI-RS transmission.

In various embodiment, the transmitted TX/RX beam report may include (e.g., indicate) the identities of the determined active TX/RX beam pair and the determined alternative TX/RX beam pair.

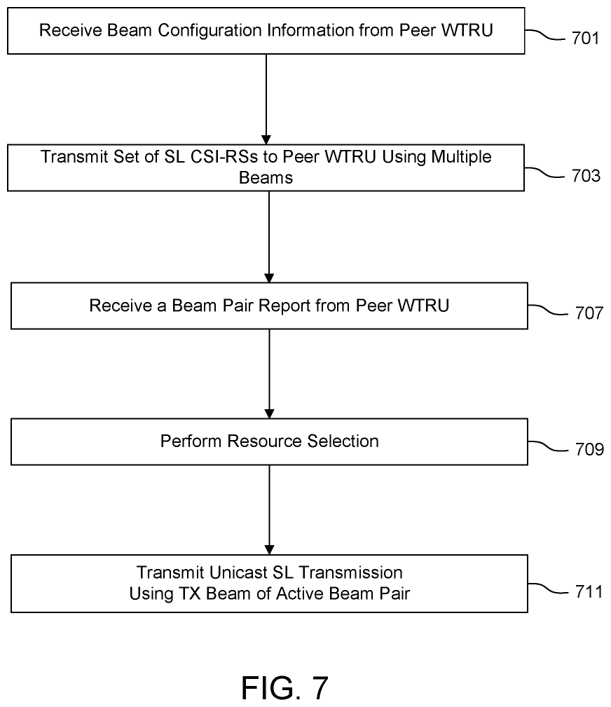

FIG. 7 is a flowchart illustrating an exemplary process for determining at least one TX/RX beam pair for communicating with a second WTRU via sidelink (SL) by determining beamforming parameters for sidelink operation via resource selection based on transmit/receive beam pair reporting from another wireless transmit/receive unit associated with a unicast sidelink. The exemplary process may be implemented in a first WTRU. The first WTRU may include circuitry including any of transmitter, a receiver, a processor, and a memory.

As shown at 701, a first WTRU (e.g., participating in sidelink communications with a second, peer WTRU) may receive beam configuration information from the second WTRU.

As shown at 703, the first WTRU may transmit a set of SL CSI-RS transmissions to the second WTRU (e.g., when at least one condition is satisfied), using multiple TX beams.

As shown at 707, the first WTRU may receive a beam pair report from the second WTRU, e.g., indicating an active (e.g., first) beam pair.

As shown at 709, the first WTRU may perform resource selection in a set of candidate slots e.g., in a resource selection window. For example, the first WTRU may determine a set of candidate slots based on the beam configuration information. In various embodiments, the set of candidate slots may be associated with a RX beam of the second WTRU in the active beam pair.

As shown at 711, the first WTRU may transmit a unicast SL (e.g., PSSCH/PSCCH) transmission e.g., in a slot of the set of candidate slots using the TX beam of the active TX/RX beam pair.

In various embodiments, the received beam configuration information may comprise (e.g., indicate) any of a number of RX beams in (e.g., the RX beam pattern of) the beam configuration information, an indication of a (e.g., each) RX beam in (e.g., the RX beam pattern of) the beam configuration information, TX beams corresponding to a (e.g., each) RX beam, and an association between a (e.g., each) RX beam pattern and a set of periodic SL (e.g., logical) slots in a resource pool.

In various embodiments, the set of CSI-RS transmissions may be transmitted to the second WTRU based on at least one condition being satisfied.

In various embodiments, the at least one condition may be satisfied based on any one or more of (a) the first WTRU being (pre)configured with periodic CSI-RS transmissions, (b) the first WTRU determining a beam failure, (c) a number of received hybrid automatic repeat request unacknowledged (HARQ-NACKs) from the second WTRU being above a first threshold, (d) a number of not received HARQ transmissions(HARQ-DTXs) being above a second threshold, (e) a number of received HARQ-NACKs and HARQ-DTXs from the second WTRU being above a third threshold, (f) a channel busy rate (CBR) measured at the first WTRU being higher than a fourth threshold, (g) a channel condition being lower or higher than a fifth threshold, (h) a time period since a last beam pair report reception being above a sixth threshold, and (i) a time period since a last channel quality index (CQI) report reception being above a seventh threshold.

In various embodiments, the channel condition may be at least one of a reference signal received power (RSRP) and a received signal strength indicator (RSSI) (e.g., having a certain value).

In various embodiments, the CSI-RS transmissions may include sidelink control information (SCI) indicating at least one of a TX beam indication and a beam pair reporting request.

In various embodiments, determining a set of candidate slots may comprise the determining a set of candidate slots in a resource selection window.

In various embodiments, the active (e.g., first) beam pair may comprise a TX beam of the first WTRU and the RX beam of the second WTRU.

In various embodiments, the first WTRU may receive the TX/RX beam report in a PSFCH.

In various embodiments, transmitting a unicast sidelink transmission may comprise transmitting a unicast sidelink transmission in any of a physical sidelink shared channel (PSSCH) and a physical sidelink control channel (PSCCH).

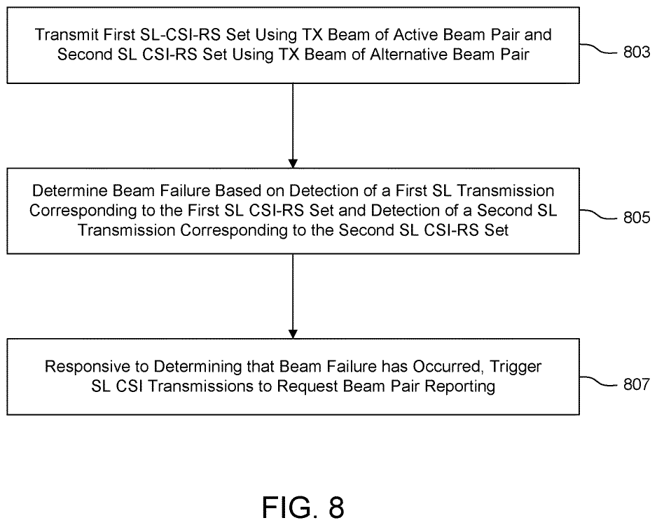

FIG. 8 is a flowchart illustrating an exemplary process for detecting beam failure in a unicast SL. The exemplary process may be implemented in a (e.g., first) WTRU. The (e.g., first) WTRU may include circuitry including any of transmitter, a receiver, a processor, and a memory.

In an example, a (e.g., first) WTRU participating in sidelink communications with a second, peer WTRU may trigger performance of beam failure detection e.g., when a condition indicative of potential beam failure is detected.

As shown at 803, (e.g., responsive to the triggering), the WTRU may transmit a first set of SL-CSI-RS transmissions using a TX beam of an active beam pair of the SL and a second set of SL CSI-RS transmissions using a TX beam of an alternative beam pair of the SL.

As shown at 805, the WTRU may determine whether a beam failure (partial or full) has occurred (e.g., may determine a beam failure to have occurred) based on detection (e.g., whether or not it receives) of a first SL (e.g., PSFCH) transmission corresponding to the first set of SL CSI-RS transmissions and/or a second SL (e.g., PSFCH) transmission corresponding to the second set of SL CSI-RS transmissions.

As shown at 807, responsive to the determining that a beam failure has occurred (e.g., if a beam failure has been determined (partial or full)), the WTRU may trigger (e.g., transmit) a third set of SL CSI transmissions, e.g., using multiple TX beams to request TX/RX beam pair reporting.

In various embodiments, transmitting the first set of sidelink CSI-RS transmissions and the second set of sidelink CSI-RS transmissions may comprise transmitting the first set of sidelink CSI-RS transmissions and the second set of sidelink CSI-RS transmissions responsive to a triggering condition being satisfied.

In various embodiments, the triggering condition may be satisfied based on at least one of (a) a number of hybrid repeat request unacknowledged (HARQ-NACKs) or not received transmissions (HARQ-DTXs) from the second WTRU being above a first threshold, (b) a channel busy ratio being higher than a second threshold, (c) a measured channel condition on the SL being higher or lower than a third threshold, (d) a time period since a last SL (e.g., physical shared channel/physical control channel (PSSCH/PSCCH)) transmission on the SL being above a fourth threshold, (e) a time period since a last beam pair report reception on the SL being above a fifth threshold, and (f) a time period since receiving a channel quality index (CQI) on the SL being above a sixth threshold.

In various embodiments, a SL CSI-RS transmission may include SCI including (e.g., indicating) at least one of a TX beam (e.g., indication) and a beam monitoring (e.g., indication).

In various embodiments, determining a beam failure to have occurred may comprise determining that beam failure has not occurred if the first SL (e.g., PSFCH) transmission is detected, determining that a partial beam failure has occurred if the first SL (e.g., PSFCH) transmission is not detected and the second SL (e.g., PSFCH) transmission is detected, and determining that full beam failure has occurred if the first SL (e.g., PSFCH) transmission and the second SL (e.g., PSFCH) transmission are not detected.

In various embodiments, if partial beam failure is determined, the WTRU may re-associate the alternative TX/RX beam pair as the active TX/RX beam pair of the SL.

In various embodiment, if the WTRU determines full beam failure, the WTRU may indicate the full beam failure to a higher layer.

In various embodiments, the active beam pair may comprise a TX beam of the (e.g., first) WTRU and a receive (RX) beam of the second (e.g., peer) WTRU.

In various embodiments, the alternative beam pair may comprise an alternative TX beam of the (e.g., first) WTRU and an alternative RX beam of the second (e.g., peer) WTRU.

In various embodiments, any of the first sidelink transmission and the second sidelink transmission may be (e.g., comprise) a physical sidelink feedback channel (PSFCH) transmission.

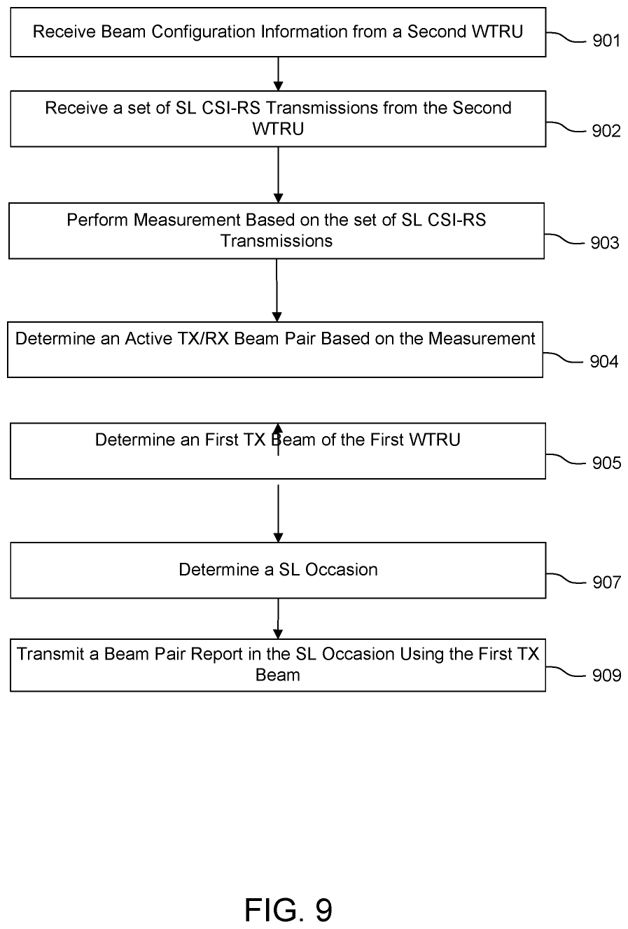

FIG. 9 is a flowchart illustrating an example process for determining and reporting beam pairs associated with a unicast sidelink. The example process may be implemented in a first WTRU. The first WTRU may include circuitry including any of transmitter, a receiver, a processor, and a memory.

As shown at 901, the first WTRU may receive beam configuration information from a second WTRU. As shown at 902, the first WTRU may receive a set of sidelink channel state information reference signal (CSI-RS) transmissions from the second WTRU. As shown at 903, the first WTRU may perform measurement based on the set of sidelink CSI-RS transmissions. As shown at 904, the first WTRU may determine an active beam pair based on the measurement. In various embodiments, the active beam pair may comprise a first receive (RX) beam of the first WTRU and a first transmit (TX) beam of the second WTRU. As shown at 905, the first WTRU may determine a first TX beam of the first WTRU corresponding to the first RX beam of the first WTRU in the active beam pair. As shown at 907, the first WTRU may determine a sidelink occasion based on the beam configuration information. In various embodiments, the sidelink occasion may be associated with a first RX beam of the second WTRU corresponding to the first TX beam of the second WTRU in the active beam pair. As shown at 909, the first WTRU may transmit a beam pair report in the sidelink occasion using the first TX beam of the first WTRU.

In various embodiments, the WTRU may determine at least one alternative beam pair based on the measurement.

In various embodiments, one of the at least one alternative beam pair may comprise an alternative first RX beam of the first WTRU and an alternative first TX beam of the second WTRU.

In various embodiments, the measurement may comprise any of a reference signal received power (RSRP) measurement and a line of sight/non-line of sight (LOS/NLOS) measurement of a CSI-RS transmission.

In various embodiments, determining the active beam pair may comprise determining the active beam pair based on a RSRP measurement associated with the active beam pair satisfying a first strength condition.

In various embodiments, the first strength condition may be satisfied if the RSRP measurement associated with the active beam pair is a highest RSRP measurement relative to other RSRP measurements associated with other beam pairs.

In various embodiments, determining at least one alternative beam pair may comprise determining the at least one alternative beam pair based on at least one RSRP measurement associated with the at least one alternative beam pair satisfying a second strength condition.

In various embodiments, the second strength condition may be satisfied if the at least one RSRP measurement associated with the at least one alternative beam pair is above a threshold.

In various embodiments, determining at least one alternative beam pair may comprise determining the at least one alternative beam pair based on at least one LOS/NLOS measurement associated with the at least one alternative beam pair satisfying a LOS/NLOS condition.

In various embodiments, a CSI-RS transmission received from the second WTRU may comprise sidelink control information (SCI) including at least one of a TX beam indication and a beam pair reporting request.

In various embodiments, the beam configuration information may indicate any of (1) a number of RX beams, (2) TX beams corresponding to a (e.g., each) RX beam, and (3) an association between a (e.g., each) RX beam in the beam configuration information and a set of periodic sidelink slots in a resource pool.

In various embodiments, the beam pair report may indicate the active beam pair.

In various embodiments, the beam pair report may indicate the at least one alternative beam pair.

In various embodiments, transmitting the beam pair report may comprise transmitting the beam pair report in a physical sidelink feedback channel (PSFCH).

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, and a memory, the circuitry being operable (e.g., configured) to process the disclosed method, with a computer program product comprising program code instructions and with a non-transitory computer-readable storage medium storing program instructions.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.) and/or “permissive” terms (e.g., the term “is” and/or the term “are” may be interpreted as “may” and/or “might”, the terms “refer(s)” may be interpreted as “may refer” and/or “might refer”, the terms “receive(s)” may be interpreted as “may receive” and/or “might receive”, the terms “support(s)” may be interpreted as “may support” and/or “might support”, the terms “interface(s)” may be interpreted as “may interface” and/or “might interface”, the terms “transmit(s)” may be interpreted as “may interface” and/or “might interface”, “may transmit” and/or “might transmit”, the terms “send(s)” may be interpreted as “may send” and/or “might send”, the terms “does not refer” (and/or the like) may be interpreted as “may not refer” and/or “might not refer”, the terms “does not receive” (and/or the like) may be interpreted as “may not receive” and/or “might not receive”, the terms “does not support” (and/or the like) may be interpreted as “may not support” and/or “might not support”, the terms “does not interface” (and/or the like) may be interpreted as “may not interface” and/or “might not interface”, the terms “does not transmit” (and/or the like) may be interpreted as “may not transmit” and/or “might not transmit”, the terms “does not send” (and/or the like) may be interpreted as “may not send” and/or “might not send”, etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1. A first wireless transmit/receive unit (WTRU) comprising circuitry, including any of a transmitter, a receiver, a processor, and memory, configured to:
receive beam configuration information from a second WTRU;
receive a set of sidelink channel state information reference signal (CSI-RS) transmissions from the second WTRU;
perform measurement based on the set of sidelink CSI-RS transmissions;
determine an active beam pair based on the measurement, wherein the active beam pair comprises a first receive (RX) beam of the first WTRU and a first transmit (TX) beam of the second WTRU;
determine a first TX beam of the first WTRU corresponding to the first RX beam of the first WTRU in the active beam pair;
determine a sidelink occasion based on the beam configuration information, wherein the sidelink occasion is associated with a first RX beam of the second WTRU corresponding to the first TX beam of the second WTRU in the active beam pair; and
transmit a beam pair report in the sidelink occasion using the first TX beam of the first WTRU.

2. The first WTRU of claim 1, configured to determine at least one alternative beam pair based on the measurement.

3. The first WTRU of claim 2, wherein one of the at least one alternative beam pair comprises an alternative first RX beam of the first WTRU and an alternative first TX beam of the second WTRU.

4. The first WTRU of claim 1, wherein the measurement comprises any of a reference signal received power (RSRP) measurement and a line of sight/non-line of sight (LOS/NLOS) measurement of a CSI-RS transmission.

5. The first WTRU of claim 1, wherein being configured to determine the active beam pair comprises being configured to determine the active beam pair based on a RSRP measurement associated with the active beam pair satisfying a first strength condition.

6. The first WTRU of claim 5, wherein the first strength condition is satisfied if the RSRP measurement associated with the active beam pair is a highest RSRP measurement relative to other RSRP measurements associated with other beam pairs.

7. The first WTRU of claim 2, wherein being configured to determine at least one alternative beam pair comprises being configured to determine the at least one alternative beam pair based on at least one RSRP measurement associated with the at least one alternative beam pair satisfying a second strength condition.

8. The first WTRU of claim 7, wherein the second strength condition is satisfied if the at least one RSRP measurement associated with the at least one alternative beam pair is above a threshold.

9. The first WTRU of claim 2, wherein being configured to determine at least one alternative beam pair comprises being configured to determine the at least one alternative beam pair based on at least one LOS/NLOS measurement associated with the at least one alternative beam pair satisfying a LOS/NLOS condition.

10. The first WTRU of claim 1, wherein a CSI-RS transmission received from the second WTRU comprises sidelink control information (SCI) including at least one of a TX beam indication and a beam pair reporting request.

11. The first WTRU of claim 1, wherein the beam configuration information indicates any of (1) a number of RX beams, (2) TX beams corresponding to each RX beam, and (3) an association between each RX beam in the beam configuration information and a set of periodic sidelink slots in a resource pool.

12. The first WTRU of claim 1, wherein the beam pair report indicates the active beam pair.

13. The first WTRU of claim 2, wherein the beam pair report indicates the at least one alternative beam pair.

14. The first WTRU of claim 1, wherein being configured to transmit the beam pair report comprises the circuitry being configured to transmit the beam pair report in a physical sidelink feedback channel (PSFCH).

15. A method implemented in a first wireless transmit/receive unit (WTRU), the method comprising:
receiving beam configuration information from a second WTRU;
receiving a set of sidelink channel state information reference signal (CSI-RS) transmissions from the second WTRU;
performing measurement based on the set of sidelink CSI-RS transmissions;
determining an active beam pair based on the measurement, wherein the active beam pair comprises a first RX beam of the first WTRU and a first TX beam of the second WTRU;
determining a first TX beam of the first WTRU corresponding to the first RX beam of the first WTRU in the active beam pair;
determining a sidelink occasion based on the beam configuration information, wherein the sidelink occasion is associated with a first RX beam of the second WTRU corresponding to the first TX beam of the second WTRU in the active beam pair; and
transmitting a beam pair report in the sidelink occasion using the first TX beam of the first WTRU.

16. The method of claim 15, comprising determining at least one alternative beam pair based on the measurement.

17. The method of claim 16, wherein one of the at least one alternative beam pair comprises an alternative first RX beam of the first WTRU and an alternative first TX beam of the second WTRU.

18. The method of claim 15, wherein the measurement comprises any of a reference signal received power (RSRP) measurement and a line of sight/non-line of sight (LOS/NLOS) measurement of a CSI-RS transmission.

19. The method of claim 15, wherein the beam pair report indicates the active beam pair.

20. The method of claim 16, wherein the beam pair report indicates the at least one alternative beam pair.
